(19) United States
(12) Patent Application Publication
(10) Pub. No.: US 2026/0201931 A1
(43) Pub. Date: Jul. 16, 2026

(54) BRAKING SYSTEM OF A MOTOR VEHICLE ELECTRICALLY DRIVEN BY AN ELECTRIC MACHINE

(71) Applicant: Schaeffler Technologies AG & Co. KG, Herzogenaurach (DE)

(72) Inventors: Doris Maria Wimmer, Ottenhöfen (DE); Simon Ortmann, Pulheim (DE); Benedikt Grubauer, Neresheim (DE); Alan Barrera Bohorquez, Karlsruhe (DE)

(73) Assignee: Schaeffler Technologies AG & Co. KG, Herzogenaurach (DE)

(21) Appl. No.: 19/136,324

(22) PCT Filed: Nov. 10, 2023
(86) PCT No.: PCT/DE2023/100856

§ 371 Date: Jun. 6, 2025

(30) Foreign Application Priority Data
Dec. 7, 2022 (DE) 10 2022 132 493.1

(51) Int. Cl. F16D 65/22; B60K 7/00; B60T 1/06; F16D 55/10; F16D 65/78; F16D 65/853; F16D 121/04

(52) U.S. Cl. CPC F16D 65/22; B60K 7/0007; B60T 1/062; F16D 55/10; F16D 65/853; B60K 2007/0092; F16D 2065/784; F16D 2121/04

(57) ABSTRACT

A braking system includes an electric machine with a rotor, a brake housing, a brake arranged in the brake housing, and an actuator. The rotor is arranged for torque-transmitting connection to a vehicle wheel. The brake has a brake disk torque-transmittingly connected to the rotor. The actuator is for applying a friction torque to the brake disk. The braking system may have a brake cooling circuit for dissipating heat from the brake.

### CROSS-REFERENCE TO RELATED APPLICATIONS

This application is the United States National Phase of PCT Appln. No. PCT/DE2023/100856 filed Nov. 10, 2023, which claims priority to German Application No. DE102022132493.1 filed Dec. 7, 2022, the entire disclosures of which are incorporated by reference herein.

### TECHNICAL FIELD

The present disclosure relates to a braking system of a motor vehicle which can be electrically driven by means of an electric machine. The braking system includes a brake with a brake disk to which friction torque can be applied by means of a brake actuator, and the electric machine has a rotor which is coupled in a torque-transmitting manner to at least one vehicle wheel of the motor vehicle.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to. A detailed description of an electric drive can be found, for example, in an article in the German automotive magazine ATZ, volume 113, May 2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for a vehicle axle comprising an electric motor arranged coaxially to a bevel gear differential.

Motor vehicles of this type with a hybridized or electrified drive train can not only accelerate but also brake with the aid of an electric machine. During braking, the electric machine is operated as a generator and the recuperated energy is used to charge the battery, for example. For safety reasons, however, an additional mechanical braking device is still required. For drives in the vicinity of the wheel, such as a wheel hub motor or an electric axle, this results in a more difficult situation in terms of installation space.

In particular, a vehicle with an electric wheel hub drive, a so-called e-wheel drive, often uses brakes with plates in order to slow down the vehicle. However, disk brakes with floating calipers, disk brakes with fixed calipers, drum brakes and multi-disk brakes are also known.

DE 10 2019 120 409 A1, for example, discloses a braking device for a wheel hub drive arrangement in which the braking partners, which are fixed relative to the circumferential direction, comprise cooling channels. The axially movable braking partner is actuated via brake cylinders. The braking partner, which is movable in the circumferential direction, is designed as a plate carrier.

There is also an increasing requirement to reduce or completely avoid brake wear emissions, which often occur as particulate matter.

### SUMMARY

The present disclosure provides an improved braking system with high braking torques, high operational safety and low brake dust emissions.

Example embodiments broadly comprise a braking system of a motor vehicle which can be electrically driven by means of an electric machine. The braking system includes a brake with a brake disk to which friction torque can be applied by means of a brake actuator, and the electric machine has a rotor which is coupled in a torque-transmitting manner to at least one vehicle wheel of the motor vehicle. The brake is accommodated in a brake housing and the brake disk is connected to the rotor of the electric machine in a torque-transmitting manner.

The braking system according to the disclosure supplements the recuperation of the electric machine in generator mode in driving situations where the electric machine alone cannot provide the desired braking energy. These are, for example, driving situations with a low vehicle speed or low speed of the electric machine or stopping to a standstill or braking at a low temperature.

With the additional, encapsulated brake, the braking energy can be transferred in the form of heat to the thermal management system of the motor vehicle without having to store the energy in the battery of the motor vehicle, for example. In addition, brake dust particles are not released into the environment. If legal regulations allow in the future, it may also be possible to dispense with the wheel brakes on one axle, for example.

This type of brake is sometimes referred to as a complementary brake.

The brake may be arranged in a brake housing. The brake housing encloses the brake. A brake housing can also accommodate one or more brake actuators. The brake housing can also be part of a cooling system, and can be designed in such a way that cooling fluid is supplied to the braking system via the brake housing and/or the heat can be dissipated to the outside via the housing surfaces. The brake housing also protects the complementary brake from external mechanical and/or chemical influences. A brake housing can be formed in particular from a metallic material. The brake housing can be formed from a metallic cast material, such as gray cast iron or cast steel. In principle, it is also conceivable to form the brake housing entirely or partially from a plastic. It is also possible for the brake housing to be designed in one piece or in several parts.

The brake housing can also be designed completely or in part as part of a motor housing of an electric machine or a transmission housing of a transmission coupled to the electric machine. The brake housing and the motor housing or the transmission housing may form a single structural unit. For example, the brake housing can be screwed to the motor housing or the transmission housing. The brake housing may be designed in such a way that wear emissions generated during braking cannot escape from the brake housing. This prevents unwanted pollution of the environment by brake wear emissions. Braking noise with respect to the environment can also be reduced by encapsulating the braking system in this way. A further aspect of this encapsulation is that the braking performance of the braking system is independent of the weather conditions outside the motor vehicle.

In particular, a brake actuator has the function of activating the brake, i.e., setting it to a frictional operating state and an operating state released from the frictional connection. In particular, the brake actuator can be actuated pneumatically, hydraulically, by means of an electric motor, mechanically, electromagnetically or any combination thereof. The brake actuator may be configured as a hydraulically actuated central release.

The braking system according to the disclosure may be provided for a motor vehicle which can be driven electrically by means of an electric machine. For the purposes of this application, electric machines are used to convert electrical energy into mechanical energy and/or vice versa, and generally include a stationary part referred to as a stator or stationary armature, and a part referred to as a rotor or moving armature and arranged movably relative to the stationary part. In connection with the present disclosure, an electric machine can be designed in particular as a rotary machine. With such electric rotary machines, a distinction is made between radial flux machines and axial flux machines. A radial flux machine is characterized in that the magnetic field lines extend in the radial direction in the air gap formed between rotor and stator, while in the case of an axial flux machine the magnetic field lines extend in the axial direction in the air gap formed between rotor and stator.

In connection with the present disclosure, an electric machine is intended in particular for use within a drive train of a hybrid or fully electrically driven motor vehicle. In particular, the electric machine is dimensioned such that vehicle speeds of more than 50 km/h, more than 80 km/h, or more than 100 km/h can be achieved. The electric machine may have an output of more than 30 kW, more than 50 kW, or more than 70 kW. Furthermore, the electric machine may provide speeds greater than 5000 rpm, greater than 10,000 rpm, or greater than 12,500 rpm.

The electric machine can have a housing, also known as a motor housing. The motor housing encloses the electric machine. A motor housing can also accommodate the control and power electronics, and, for example, also at least parts of the braking system. The motor housing can also be part of a cooling system for the electric machine, and can be designed such that cooling fluid can be supplied to the electric machine via the motor housing and/or the heat can be dissipated to the outside via the motor housing surfaces. In addition, the motor housing protects the electric machine and any electronics that may be present from external mechanical and/or chemical influences. A motor housing of the electric machine can be formed in particular from a metallic material. The motor housing can be formed from a metallic cast material, such as gray cast iron or cast steel. In principle, it is also conceivable to form the motor housing entirely or partially from a plastic. It is also possible for the motor housing of the electric machine to be designed in one piece or in several parts.

A rotor is the rotating (spinning) part of an electric machine. The rotor includes a rotor shaft and one or more rotor bodies formed of rotor lamination stacks which are arranged on the rotor shaft in a non-rotatable manner. The rotor shaft can be hollow, which on the one hand results in weight savings and on the other hand allows the supply of lubricant or coolant to the rotor body. In particular, the rotor shaft can be coupled to the brake shaft of the complementary brake.

The electric machine and/or the brake can be coupled to a transmission, which is designed in particular to generate a drive torque for the motor vehicle. The drive torque may be a main drive torque, such that the motor vehicle is driven exclusively by the drive torque.

It is also possible in particular for the electric machine and/or the brake and the transmission to be arranged in a common drive train housing. Alternatively, it would of course also be possible for the electric machine to have a motor housing and the transmission to have a transmission housing, and the structural unit can then be brought about by fixing the transmission arrangement in relation to the electric machine. This structural unit is sometimes also referred to as an e-axle. The drive train housing may be formed from a metallic material, e.g., from aluminum, gray cast iron or cast steel, in particular by means of a primary shaping process such as casting or die-casting. In principle, however, it would also be possible to form the drive train housing from a plastic material. The drive train housing may have a cup-like basic shape, such that the electric machine and the transmission can be inserted into the drive train housing via the open end face thereof.

The electric machine may have a motor housing and/or the transmission may have a transmission housing, and the structural unit can then be implemented by fixing the transmission in relation to the electric machine. The transmission housing is a housing for accommodating a transmission. It has the task of guiding existing shafts via the bearings and giving the wheels (cam disks, where applicable) the degrees of freedom they require under all loads without impeding their rotational and possible path movement, as well as absorbing bearing forces and supporting torques. A transmission housing can be designed as single-shell or multi-shell, i.e., undivided or divided. In particular, the transmission housing should be able to dampen noise and vibrations as well as safely absorb hydraulic fluid. The transmission housing may be formed from a metallic material, e.g., from aluminum, gray cast iron or cast steel, in particular by means of a primary shaping process such as casting or die-casting.

Furthermore, the transmission can be configured as a planetary transmission or include a planetary transmission. The planetary transmission can have a sun gear and a plurality of planet gears meshing with the sun gear and rotatably mounted in a planet gear carrier, which planet gears rotate around the sun gear, as well as a ring gear arranged coaxially to the sun gear, in which the planet gears roll.

The transmission can also have a differential gear. A differential gear is a planetary transmission with one drive and two outputs. It usually has the function of driving two vehicle wheels of a motor vehicle in such a way that they can turn at different speeds when cornering, but with the same propulsive force.

In order to implement different driving or operating modes for the motor vehicle, one or more separating clutches can be provided within the torque path between the electric machine and a vehicle wheel. A separating clutch can be arranged between the output of the electric machine and the input of the transmission, for example, so that the electric machine can be decoupled from the transmission, allowing the motor vehicle to be operated in coasting mode. It would also be conceivable to arrange a separating clutch between the output of the transmission and a vehicle wheel or the vehicle wheels, which would also make it possible to implement a coasting mode of the motor vehicle. Finally, it is also possible to arrange a separating clutch between the input of the braking system and the output of the electric machine, which allows the braking system to be completely decoupled from the electric machine.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches, or tractors.

Features listed individually in the example embodiments can be combined with one another in a technologically meaningful manner and can define further embodiments. In addition, the features indicated are specified and explained in more detail in the description, wherein further embodiments are shown.

According to an example embodiment, it can be provided that the braking system has a brake cooling circuit for dissipating heat from the brake. The heat generated by the frictional energy of the brake can be dissipated and made available to a thermal management system of a motor vehicle, for example. Furthermore, cooling the brake can increase its braking performance and, in particular, reduce thermal fading, i.e., heat-related loss of braking force.

In the context of the present disclosure, the term thermal management refers to the demand-oriented and efficient control of thermal energy flows in an electrically powered vehicle, in particular a battery-powered vehicle, according to the prevailing operating or load condition.

The thermal management system of the motor vehicle can include a hydraulic control system. A hydraulic control system directs the volume flows within a thermal management system of a motor vehicle by means of switching elements that hydraulically act on a fluid, such as valves, slides, pumps and the like. The hydraulic control system can, for example, completely or partially throttle a volume flow and/or distribute it to the relevant heat sources and sinks in sub-circuits of the thermal management system of a motor vehicle. For this purpose, the hydraulic switching elements are controlled and switched by the electronic control unit.

A hydraulic switching element can be a hydraulic pump, a switching valve, a controllable throttle valve and the like. A hydraulic switching element can be electrically controlled. Furthermore, a hydraulic switching element may have at least two different switchable operating states in which the hydraulic switching element acts in different ways on the corresponding fluid in a circuit.

According to an example embodiment, it can therefore be provided that the brake has a brake cooling circuit for dissipating or supplying heat from or to the brake, and the hydraulic control unit acts on the brake cooling circuit by means of at least one hydraulic switching element to influence the volume flows in the brake cooling circuit.

According to an example embodiment, it can be provided that the electric machine has a motor cooling circuit for dissipating or supplying heat from or to the electric machine, and the hydraulic control unit acts on the motor cooling circuit by means of at least one hydraulic switching element to influence the volume flows in the motor cooling circuit.

According to an example embodiment, it can be provided that the thermal management system also includes an inverter with an inverter cooling circuit for dissipating or supplying heat from or to the inverter, and the hydraulic control unit acts on the inverter cooling circuit by means of at least one hydraulic switching element to influence the volume flows in the inverter cooling circuit.

According to an example embodiment, it can be provided that the vehicle battery has a battery cooling circuit for dissipating or supplying heat from or to the vehicle battery, and the hydraulic control unit acts on the battery cooling circuit by means of at least one hydraulic switching element to influence the volume flows in the battery cooling circuit.

According to a further embodiment, it can be provided that the brake disk is in two parts with a first brake disk shell and a second brake disk shell which are axially displaceable relative to one another and define an internal, annular pressure chamber which can be pressurized by a hydraulic fluid, so that the brake disk shells can be hydraulically displaced in the axial direction and can thereby be subjected to torque at their respective outer end faces. This has the particular effect that two friction surfaces can be formed on the end faces, so that a correspondingly high friction torque can be provided in a comparatively small axial installation space. Furthermore, this design allows the brake actuator to be virtually integrated into the brake disk, which also contributes to a particularly compact axial design of the brake.

In an example embodiment, the brake disk shells can be brought into frictional engagement with the brake housing.

This measure also contributes to an axially compact brake design and also enables good heat transfer into the brake housing.

In an example embodiment, it can also be provided that at least one cooling channel connected to the brake fluid circuit runs in the brake housing in the region of the frictional connection with the brake disk shells, whereby effective heat dissipation from the brake can be achieved.

In an example embodiment, the two-part brake disk is connected in a non-rotatable manner to a brake shaft coupled to the rotor of the electric machine, so that the braking torque generated can be transmitted from the brake disk to the rotor.

According to an example embodiment, it can be provided that the internal pressure chamber of the two-part brake disk is connected to a hydraulic channel running through the brake shaft, which also favors a particularly compact brake design.

Finally, the disclosure implemented in such a way that the brake is configured as a dry-running brake. The braking system may be designed as a “dry” braking system that has cooling channels or cooling hoses in one of the brake components—e.g., in the non-rotating component. Via these channels or hoses, coolant, for example a water-glycol mixture or a cooling oil, is transported to the thermal management system of the motor vehicle. Compared to a “wet” (multi-disk) braking system, a “dry” braking system generates fewer losses when not actuated and the coefficient of friction and therefore the braking torque is more constant.

### BRIEF DESCRIPTION OF THE DRAWINGS

The present disclosure is explained in more detail below with reference to figures without limiting the general concept.

In the figures:

FIG. 1 shows an axle drive train with a braking system in an axial sectional view,

FIG. 2 shows a braking system in a schematic axial sectional view,

FIG. 3 shows a motor vehicle with an electric drive train in a schematic block diagram.

### DETAILED DESCRIPTION

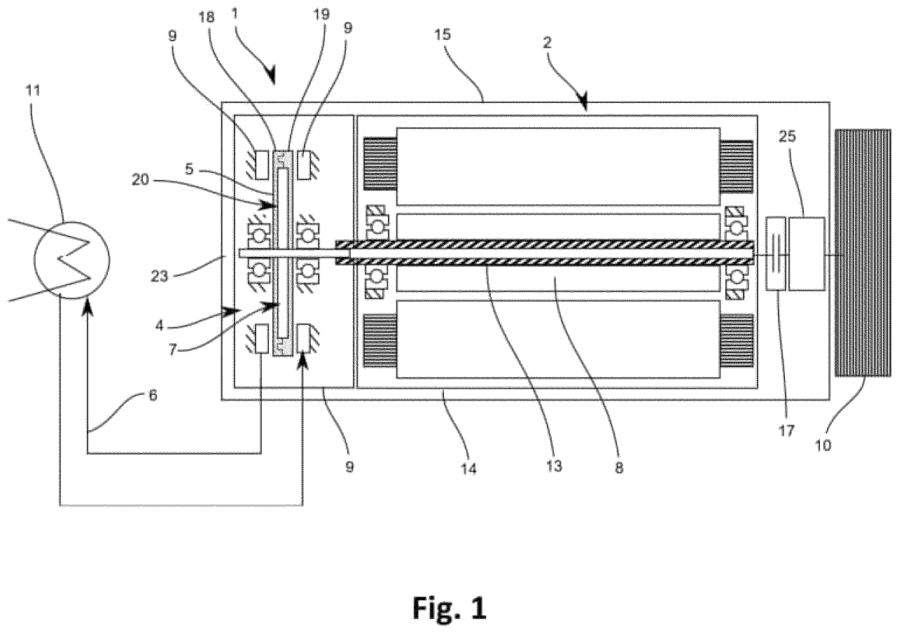

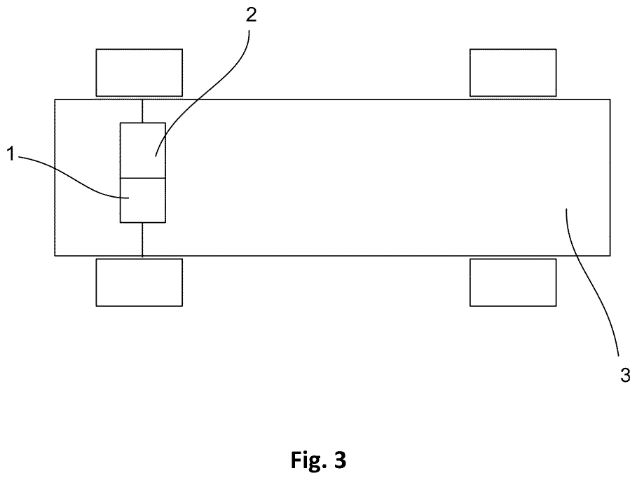

FIG. 1 shows a braking system 1 of a motor vehicle 3 which can be electrically driven by means of an electric machine 2, as shown by way of example in FIG. 3. The braking system 1 includes a brake 4 with a brake disk 5 to which a friction torque can be applied by means of a brake actuator 7. The electric machine 2 accommodated in the motor housing 14 has a rotor 8, which is coupled in a torque-transmitting manner to at least one vehicle wheel 10 of the motor vehicle 3. The brake 4 is accommodated in a brake housing 9 and the brake disk 5 is connected to the rotor 8 of the electric machine 2 in a torque-transmitting manner, so that a braking torque generated by the brake 4 can act on the vehicle wheel 10 via the rotor 8. For this purpose, the brake disk 5 is connected in a non-rotatable manner to a brake shaft 23 coupled to the rotor shaft 13 of the electric machine 2.

The transmission 25, the electric machine 2 and the brake 4 form a structural unit, which is also referred to as the axle drive train 15. In order to decouple the electric machine 2 from the vehicle wheel 10 and thus allow a coasting mode of the axle drive train 15, a separating clutch 17 is arranged in the torque path between the electric machine 2 and the vehicle wheel.

The braking system 1 also has a brake cooling circuit 6 for dissipating heat from the brake 4. The brake cooling circuit 6 is decoupled from the friction surfaces of the brake 4, so that the brake 4 is configured as a dry-running brake. The dissipated heat is then made available to a thermal management system of the motor vehicle 3 via the heat exchanger 11.

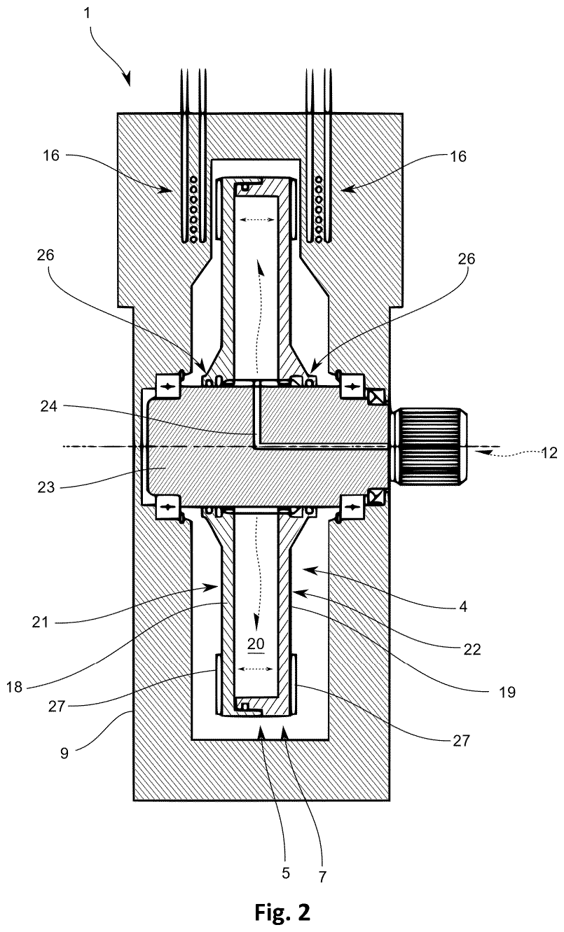

In the embodiment shown, the hydraulically actuatable brake actuator 7 is integrated into the two-part brake disk 5, and the two brake disk shells 18, 19 can be axially displaced by applying hydraulic pressure to the pressure chamber 20 formed inside the brake disk 5 by means of a hydraulic fluid 12, which can be clearly seen in FIG. 2. FIG. 2 also shows that the brake disk 5 is in two parts with a first brake disk shell 18 and a second brake disk shell 19 which are axially displaceable relative to one another and define an internal, annular pressure chamber 20 which can be pressurized by a hydraulic fluid 12, so that the brake disk shells 18, 19 can be hydraulically displaced in the axial direction and can thereby be subjected to torque at their respective outer end faces 21, 22.

The two brake disk shells 18, 19 are each sealed against the brake shaft 23 by a seal 26, which is axially secured in the respective brake disk shell 18, 19, by means of which it can be axially moved onto the brake shaft 23. It is understood that the two-part brake disk 5 is connected in a non-rotatable manner to a brake shaft 23 coupled to the rotor 8 of the electric machine 2 in order to transmit the braking torque, via the brake shaft 23, to the rotor 8 of the electric machine 2 and subsequently also to the vehicle wheel 10 in the torque flow. This non-rotatable and axially displaceable arrangement of the brake disk shells 18, 19 can be achieved, for example, by means of a plug-in toothing.

The brake disk shells 18, 19 are U-shaped in cross-section and engage axially with one another at the radially outer diameter and are sealed by the seal 28. This means that the entire pressure chamber 20 is sealed off from the surroundings by the seals 26, 28.

The brake disk shells 18, 19 can be brought into frictional engagement with the brake housing 9 when the pressure chamber 20 is pressurized and, under this hydraulic pressure, the brake disk shells 18, 19 are axially displaced in the direction of the brake housing 9. In order to dissipate the frictional heat generated during a braking process, at least one cooling channel 16 connected to the brake cooling circuit 6 runs in the brake housing 9 in the region of the frictional connection with the brake disk shells 18, 19.

Brake linings 27 are present on the brake disk shells 18, 19, which, together with one of the wall sections of the brake housing 9 extending in a radial plane, form a friction pairing as soon as the pressure chamber 20 is pressurized and the two brake disk shells 18, 19 move axially away from one another. The cooling channels 16, which conduct the heat generated by friction to the thermal management system, are arranged either on one part or in an annular manner in the brake housing 9 at the level of the friction surface.

The internal pressure chamber 20 of the two-piece brake disk 5 is connected to a hydraulic channel 24 running through the brake shaft 23, which has a channel section running coaxially to the axis of rotation of the brake shaft 23 and a channel section running radially and opening into the pressure chamber 20.

It can easily be seen from the separation of the cooling and hydraulic circuits that the brake 4 is configured as a dry-running brake 4.

FIG. 3 also shows that the brake shaft 23 is rotatably mounted in the brake housing 9. As already explained above, this brake shaft 23 has a connection to the rotor 8 of the electric machine 2 and therefore rotates at the motor speed. Alternatively, it would also be possible to arrange the brake 4 behind the transmission 25 in the torque flow, so that in this case the brake shaft 23 rotates at the wheel speed of the vehicle wheel 10. In certain driving situations, which are regulated by the vehicle control system, the brake 4 is then actuated by pressurizing the pressure chamber 20.

The present disclosure is not limited to the embodiments shown in the figures. The above description is therefore not to be regarded as limiting, but rather as illustrative. The following claims are to be understood as meaning that a stated feature is present in at least one embodiment. This does not exclude the presence of further features. Where the claims and the above description define “first” and “second” features, this designation serves to distinguish between two features of the same type without defining an order of precedence.

### REFERENCE NUMERALS

1 Braking system
2 Electric machine
3 Motor vehicle
4 Brake
5 Brake disk
6 Brake cooling circuit
7 Brake actuator
8 Rotor
9 Brake housing
10 Vehicle wheel
11 Heat exchanger
12 Hydraulic fluid
13 Rotor shaft
14 Motor housing
15 Axle drive train
16 Cooling channel
17 Separating clutch
18 Brake disk shell
19 Brake disk shell
20 Pressure chamber
21 End face
22 End face
23 Brake shaft
24 Hydraulic channel
25 Transmission
26 Seal
27 Friction lining
28 Seal

1. A braking system of a motor vehicle which can be electrically driven by means of an electric machine, wherein the braking system comprises a brake with a brake disk to which friction torque can be applied by means of a brake actuator, and the electric machine has a rotor which is coupled in a torque-transmitting manner to at least one vehicle wheel of the motor vehicle,
wherein:
the brake is accommodated in a brake housing and the brake disk is connected to the rotor of the electric machine in a torque-transmitting manner.

2. The braking system according to claim 1,
wherein:
the braking system has a brake cooling circuit for dissipating heat from the brake.

3. The braking system according to claim 2,
wherein:
the brake disk is in two parts with a first brake disk shell and a second brake disk shell which are axially displaceable relative to one another and define an internal, annular pressure chamber which can be pressurized by a hydraulic fluid, so that the brake disk shells can be hydraulically displaced in the axial direction and can thereby be subjected to torque at their respective outer end faces.

4. The braking system according to claim 3,
wherein:
the brake disk shells can be brought into frictional engagement with the brake housing.

5. The braking system according to claim 3,
wherein:
at least one cooling channel connected to the brake cooling circuit runs in the brake housing in the region of the frictional connection with the brake disk shells.

6. The braking system according to claim 3,
wherein:
the brake disk is connected in a non-rotatable manner to a brake shaft coupled to the rotor of the electric machine.

7. The braking system according to claim 6,
wherein:
the internal pressure chamber of the brake disk is connected to a hydraulic channel running through the brake shaft.

8. The braking system according to claim 1,
wherein:
the brake is configured as a dry-running brake.

9. A braking system comprising:
an electric machine comprising a rotor arranged for torque-transmitting connection to a vehicle wheel;
a brake housing;
a brake arranged in the brake housing and comprising a brake disk torque-transmittingly connected to the rotor; and
an actuator for applying a friction torque to the brake disk.

10. The braking system of claim 9 further comprising a brake cooling circuit for dissipating heat from the brake.

11. The braking system of claim 9, wherein the brake disk comprises:
a first brake disk shell comprising an outer face; and
a second brake disk shell comprising an outer face, wherein:
the first brake disk shell and the second brake disk shell are axially displaceable relative to one another; and
the first brake disk shell and the second brake disk shell define an internal, annular pressure chamber arranged to be pressurized by a hydraulic fluid to axially displace the first brake disk shell and the second brake disk shell, subjecting them to torque at their respective outer faces.

12. The braking system of claim 11, wherein the first brake disk shell and the second brake disk shell are arranged for frictional engagement with the brake housing.

13. The braking system of claim 12 further comprising:
a brake cooling circuit for dissipating heat from the brake; and
a cooling channel connected to the brake cooling circuit and arranged in the brake housing proximate to the frictional engagement.

14. The braking system of claim 11 further comprising a brake shaft coupled to the rotor, wherein the brake disk is non-rotatably connected to the brake shaft.

15. The braking system of claim 14 further comprising a hydraulic channel running through the brake shaft and connected to the internal, annular pressure chamber.

16. The braking system of claim 9, wherein the brake is a dry-running brake.
